(19) United States
(12) Patent Application Publication
(10) Pub. No.: US 2016/0281311 A1
(43) Pub. Date: Sep. 29, 2016

(54) Wireless sensor system for tracking and controlling maintenance and spreading equipment

(71) Applicant: Andrew Jaccoma, Dover, NH (US)

(72) Inventor: Andrew Jaccoma, Dover, NH (US)

(21) Appl. No.: 14/999,068

(22) Filed: Mar. 23, 2016

Related U.S. Application Data
(63) Continuation-in-part of application No. 14/080,142, filed on Nov. 14, 2013, now abandoned.

(51) Int. Cl. E01H 10/00; G05D 1/02; G05D 1/00

(52) U.S. Cl. CPC E01H 10/007; G05D 1/0094; G05D 1/0011; G05D 1/0287

(57) ABSTRACT

Described herein are devices and techniques for automating vehicle mounted spreading systems such as deicing systems for winter road maintenance vehicles and/or agricultural spreading systems by use of an electronic control system configured to operate a distribution element drive system.

### CROSS-REFERENCES TO RELATED APPLICATIONS

This application claims the benefit of Provisional U.S. Patent Application Ser. No. 61/857,017 filed on Jul. 22, 2013, and Provisional U.S. Patent Application Ser. No. 61/726,207 filed on Nov. 14, 2012, both of which are fully incorporated by reference herein for all purposes. This application is also a continuation in part of the following U.S. patent application Ser. No. 14/080,142 entitled “Automated Control of Spreading Systems”, filed on Nov. 14, 2013, the entirety of which is incorporated herein by reference.

### BACKGROUND OF THE INVENTION

The spreader system, road maintenance equipment, monitoring equipment and methods (“Technology”) described herein, encompass a series of innovations that are aimed at increasing the efficiency of the winter road maintenance industry, improving operational efficiencies, saving money, increasing safety and reducing the impact of chloride on the environment (and infrastructure).

In the parts of the world that receive various amounts of snow fall each winter, keeping roads clear of ice and snow is a necessity. This is typically achieved by plowing roadways and then spreading deicing and/or abrasive aggregate on road surfaces with spreaders. Chloride based deicers typically come in two different forms, granulated and liquid. Granulated forms (usually chloride based) are typically spread using conveyor type conveyance systems. Liquid based deicers are also used in winter road maintenance operations. Liquid deicers are typically held in liquid storage tanks and use liquid pumps to spray the road ways with brine liquids before winter events occur in order to coat the roadway with a brine solution, thus reducing the ability for ice to form on the road surface.

There are a large assortment of spreader and spreader controller manufacturers on the market. Existing Spreader Controllers rely on wired connections for connectivity to sensory devices throughout the truck for feedback on system function. These systems are typically controlled manually by the driver, set at a single speed or calibrated for various speeds of the vehicle through a velocity controlled system. Like spreader controllers, plow controller sensors also rely on hardwiring for feedback on plow function.

According to best management practices in the winter road maintenance industry (for example), certain spread rates should be prescribed for different temperatures and environments. Some spreader controllers take variations in temperature (and environment) into account through the use of externally wired sensors enabling the detection of changes in temperature and in the environment.

Chloride based deicers are the most widely used of the deicers because of their availability and low cost, however their use has long lasting negative impacts on the areas in which they are used. Such deicers negatively impact at least the following: drinking water quality, aquatic ecosystems, and infrastructure (bridges in particular).

Winter road maintainers (and plow truck operators in particular) have the propensity to overuse aggregates, this is largely due to the fact that they need to manage many different aspects of the plowing operation concurrently (controlling multiple plow controls, controlling the spreader, driving in tedious driving conditions, navigating traffic, communicating with their supervisor and typically working very long hours). While dispensing material during a winter event, it can be difficult to see where material has been applied, and when in doubt, maintainers typically choose to apply material rather than not applying material (often reapplying it redundantly). The winter road maintenance industry is in need of new technologies that can assist the winter road maintainers in applying deicer and abrasives in the most efficient manner. Furthermore, the installation of wired sensory systems on the maintenance vehicles can be tedious and expensive.

In addition to driving the vehicle on which a spreading system is mounted, the operators of such systems are typically relied on for activation and volumetric control of the spreader, which commonly results in excessive use of aggregate. Excessive use of material usually is caused by: utilizing open loop control systems, fear of not applying enough material and overcompensating and overlapping (or redundant applications within short time periods).

Winter road maintenance operations can offer very corrosive and tough environments that tend to damage electrical wiring and connections. Also, many municipalities are slow to adopt new and advantageous technologies because of the lack of technical man-power needed to install and maintain them, especially for hardwired or hardware based systems.

Furthermore, even absent the operator's other responsibilities, because the operator is generally responsible for using manual throttling controls for activation and volumetric control of the spreading system (e.g., to increase or decrease application rates), it can be very difficult for the operator to provide precise, efficient, optimized application of deicing material. This problem is compounded in systems without mass flow feedback and/or systems with coarse application rate controls.

The ability to maintain winter roads with an easily-integrated automated spreading system may allow the maintainer to focus on other aspects of the operation and enable material to be spread, for example, based on the trucks location and historical spreading information while using materials in the most economical fashion, thus contributing to safer and more sustainable winter road maintenance.

A need therefore exists for easy-to-integrate systems and methods of monitoring and automatically dispensing aggregate in order to avoid waste and optimize (winter) road maintenance operations. A system that is easy to integrate into existing vehicles with minimal or no modification to the vehicle would decrease the cost, time, and skill-level required to integrate the monitoring system. Such a system would allow municipalities, for example, with tight budgets to keep their existing vehicle fleet while retrofitting a control system to monitor and control a vehicle's operations.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic illustrating a plurality of mobile vehicles having sensors in wireless communication with a database in the cloud which in turn communicates wirelessly with a mobile device.

FIG. 2 illustrates typical components comprising a wireless sensor.

FIG. 3 illustrates a schematic of a wireless system for monitoring equipment on a road maintenance truck.

FIG. 4 illustrates a schematic of a wireless system for monitoring and controlling spreading equipment on a road maintenance truck.

FIG. 5 illustrates a schematic of a wireless system for monitoring and controlling plowing equipment on a road maintenance truck.

FIG. 6 illustrates a schematic of a wireless system for monitoring local weather conditions at a vehicle.

FIG. 7 illustrates a schematic of a wireless system for monitoring weather conditions at a vehicle and automated wireless control of a spreader system based on observed local conditions.

FIG. 8 illustrates a schematic of a wireless system for monitoring wearable wireless sensor information through a wireless hub, communicating maintenance equipment function at a maintenance vehicle wirelessly to the operator for the control and regulation of maintenance equipment.

FIG. 9 illustrates a schematic of a wireless system for monitoring wearable wireless sensory information, and communicating maintenance equipment function at a maintenance vehicle wirelessly to the operator for the control and regulation of maintenance equipment.

FIG. 10 illustrates a schematic of a wireless system for monitoring system and operator information through multiple wireless hubs for the control and regulation of maintenance equipment.

FIG. 11 illustrates a schematic of a wireless system for monitoring the status of critical switches for the control of maintenance equipment using current sensing and wireless communications for operational monitoring.

FIG. 12 illustrates a schematic of a wireless system for monitoring the status of critical switches for the control of maintenance equipment using current sensing and wireless Bluetooth (or other forms of wireless) communications for operational monitoring.

FIG. 13 illustrates a schematic of a wireless system for monitoring wireless sensory information at various locations onboard a vehicle, and communicating maintenance equipment function at a maintenance vehicle wirelessly to a mobile device to communicate information to the operator and for the control of maintenance equipment.

FIG. 14 illustrates the location, onboard a vehicle, of a wireless rotational rate sensor for sensing the rotation of a conveyance system.

FIG. 15A illustrates another view of the mounting location of a wireless rotational rate sensor for retrofit mounting on a winter road maintenance vehicle.

FIG. 15B illustrates an example of a mounting configuration for a wireless rotational rate sensor.

FIG. 15C is a more detailed view of an embodiment of a wireless rotational rate sensor that is mounted to a conveyor shaft.

FIG. 15D is an exploded view showing the electronic components inside of a wireless rotational rate sensor that is mounted to a conveyor.

FIG. 16 is a detailed view of the rear of a spreader hopper illustrating one embodiment of an angle measurement sensor. The angle measurement sensor is shown mounted at one end to the hopper and at the other end to the gate.

FIG. 17 illustrates an embodiment of a rear view of a gate showing a wireless angle sensor and the associated mounting configuration.

FIG. 18A illustrates a rear view of a gate showing a wireless angle sensor and the angle created when the gate is at first gate height setting.

FIG. 18B illustrates rear view of a wireless angle sensor and the angle created when the gate is in an alternative position.

FIG. 19A illustrates a rear view of a gate showing a wireless angle sensor and the angle created when the gate is at first gate height setting along with a reference angle measurement sensor.

FIG. 19B illustrates a rear view of a gate showing a wireless angle sensor and the angle created when the gate is at an alternative gate height setting along with a reference angle measurement sensor.

FIG. 19C is a perspective view of a gate showing a wireless angle sensor and the angle created when the gate is at an alternative gate height setting along with a reference angle measurement sensor.

FIG. 20 illustrates a detailed view of a wireless angle sensor mounted on a plow frame for measuring the orientation of the plow.

FIG. 21A illustrates an example of an angle created when the plow is lifted up.

FIG. 21B illustrates an example of an angle created when the plow is in a down configuration.

FIG. 22 is a schematic of a wireless sensor for measuring the status of electrical switches communicating wirelessly to a mobile device.

FIG. 23 is an exploded view of an embodiment of a retrofitted wireless rotational rate sensor attached to the axle shaft of a material spreader.

### DETAILED DESCRIPTION OF THE INVENTION

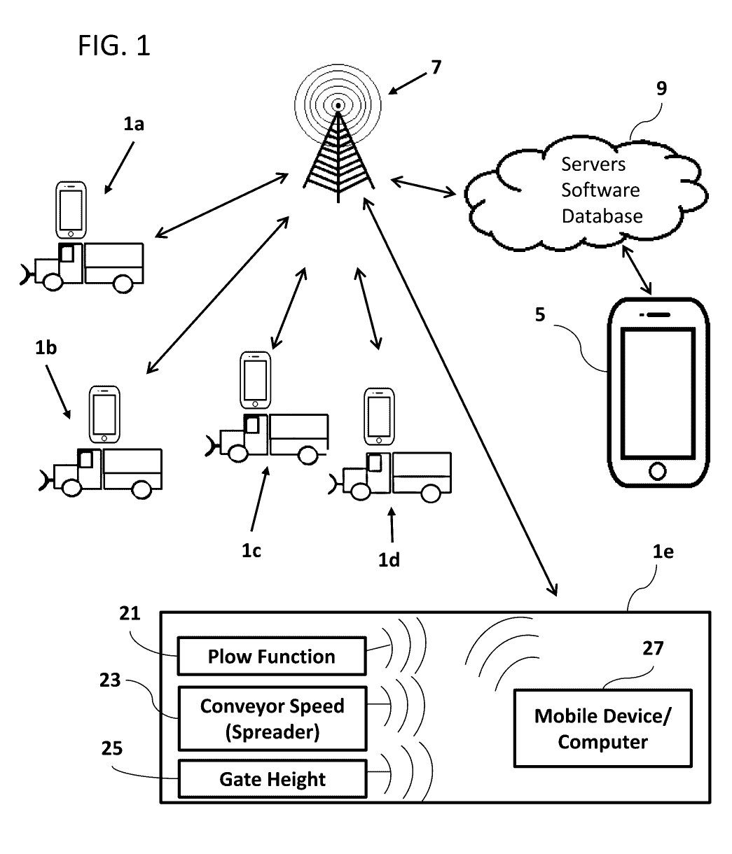

Several embodiments of the present invention are described in the following detailed description with references to FIGS. 1-23. Other embodiments may be used and may incorporate changes in structural, logical, software, and hardware elements; such changes may be made without departing from the scope of the present invention. For simplicity, the embodiments of this invention are described with reference to a winter road maintenance vehicle. However, it is within the scope of this invention that the vehicle may be any utility vehicle, for example, a vehicle for use in farming or affecting on or off-road landscapes.

The present embodiments teach systems that use wireless sensors that wirelessly connect to mobile devices (or other types of computers) using, but not limited to, Bluetooth (and BLE Bluetooth low energy), wifi, ZigBee, and other types of radio communicators to communicate sensor device(s) to mobile device(s).

Road maintenance operations may be significantly optimized through the use of mobile devices along with wireless sensors capable of communicating these mobile devices (and or computer) for several reasons.
a) Mobile devices are increasingly common and will continue to be at the leading edge of technological advancement.
b) The ability to quickly and easily mount sensors throughout a vehicular system is appealing, in contrast to the difficulty in connecting and routing wired sensors throughout a vehicle.
c) The combination of sensors and mobile devices (connected to the World Wide Web) allows for the collection, storage, and analysis of stored or real-time data.

A system connected to the World Wide Web capable of receiving real-time fleet data and also capable of providing real-time fleet data to the vehicle operator will not only help the operator make more informed decisions but will also provide real-time insight to managers of the operation.

Now with reference to FIG. 1, it can be seen how information flow may function using wireless sensors with mobile devices in certain embodiments. In FIGS. 1: 1a, 1b, 1c, 1d, 1e, and 5 all represent mobile devices communicating information (flow indicated by the arrows) gathered from wireless sensors and transmitted to a cloud computer 9 communicating with the mobile devices, wherein 1a through 1e represent vehicles equipped with wireless communication capabilities. FIG. 1 also illustrates a more detailed schematic 1e of onboard wireless sensors on a vehicle gathering information and communicating the information wirelessly with a mobile device that may reside in the vehicle (additional detail provided throughout this disclosure). A cellular antenna 7 (or other type of antenna or dish) transmits wireless data to remote servers (as well as to other mobile devices). It will be understood by one skilled in the art that the “antenna” 7 may be any other current or future technology for relaying communications signals, such as a cellular antenna or satellite. Cloud based Servers, Software and Databases 9 which may be capable of collecting, storing, sorting and sharing information from mobile networks and devices, which may in-turn store, analyze, and relay the information to other servers or, for example, back to the vehicle fleet 1a through 1e.

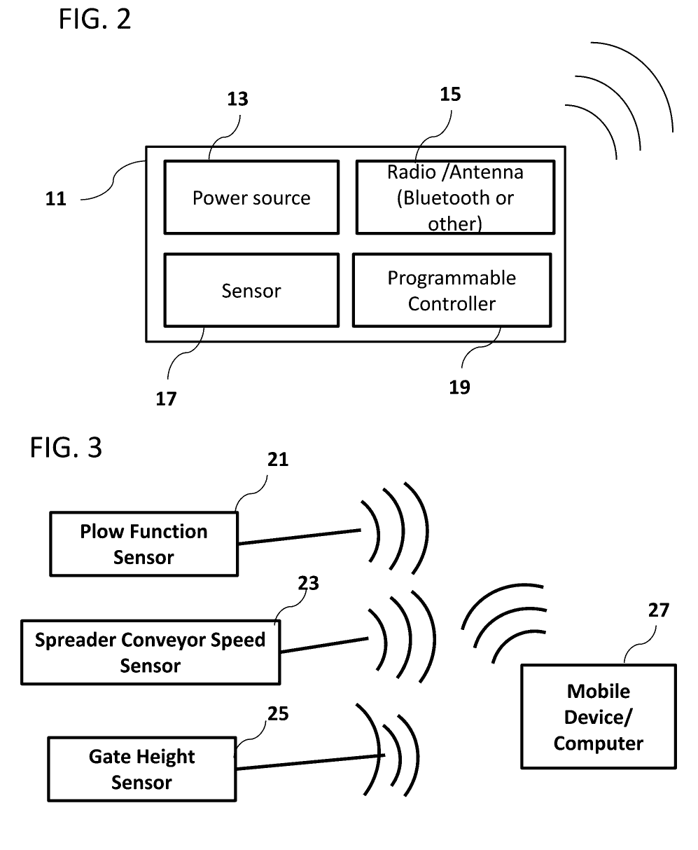

In addition to using wireless devices to communicate to and from vehicles, wireless technology may also be used to communicate between devices within a vehicle. With reference to FIG. 2 a schematic of a wireless device 11 is illustrated. The device, which may for example be a sensor attached to a mechanism on the vehicle comprises a power source 13, an antenna 15, a sensor 17, and optionally a controller 19. These device elements enable the device to communicate wirelessly with, for example, a mobile device in the passenger compartment of the vehicle. The information communicated therein, may be stored, analyzed, and/or relayed to any other device as illustrated in FIG. 1.

The power source 13 illustrated in FIG. 2 may be a storage device such as a battery. Additionally, the power source 13 may comprise a power generating device such as a dynamo, generator, or inertial power generator that takes advantage of a dynamic motion inherent in the vehicle, such as a drive shaft rotation, to generate energy (from kinetic energy) which can be used directly, thus obviating a battery, or used to charge a battery electrically attached to the sensor. The sensor 17 may be used to detect attributes of the vehicle such as the plow angle or the spread rate of material.

FIG. 3 illustrates an example of wireless sensors incorporated into a winter road maintenance operation. With regard to the Plow Function Sensor 21, the mobile device 27 may receive information from wireless sensors which may include but are not be limited to: proximity sensors, optical sensors, switch sensors, angle sensors or other types of sensors to detect plow function (plow up and plow down for example). The Spreader Conveyor Speed sensor 23 may be mounted in such a way that it can monitor the actual speed at which the conveyance mechanism is operating. Conveyance speed sensing on a spreader may be achieved utilizing proximity sensors, optical sensors, angle sensors, rotation rate sensors, gravity or other types of sensors. In winter road maintenance operations, the gate height typically controls the amount of material that falls out of the hopper. As such, the Gate Height sensor 25 offers another application where a wireless sensor may be mounted to detect changes in height of the gate which may in turn be used to calculate quantities of material expelled.

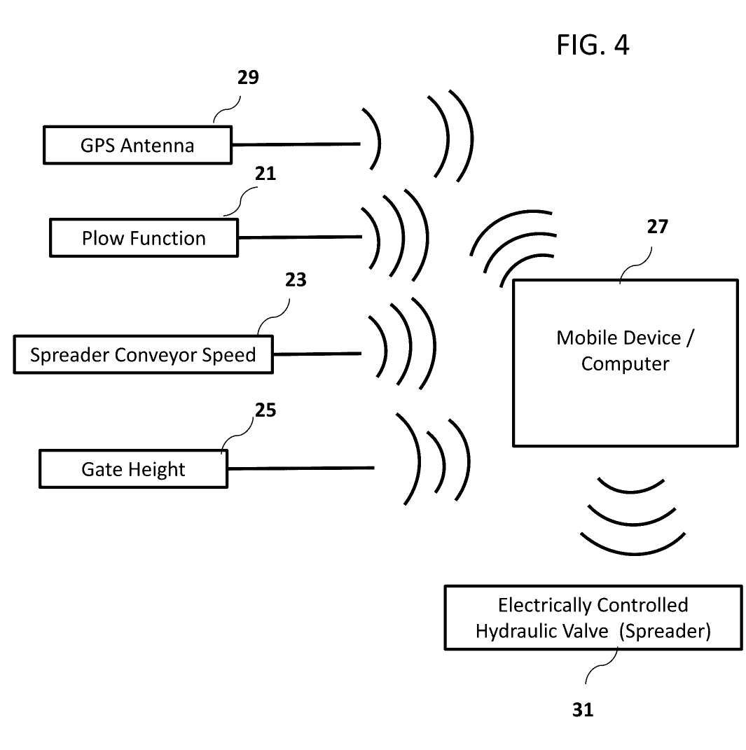

As illustrated in FIG. 4, additional system components can also be connected wirelessly to communicate with a mobile device 27 in order to improve a winter road maintenance operation (for example). Such additional components may include a wireless GPS antenna 29 for increased position system accuracy. For example, utilizing wireless communication to control the spreader control valve 31 via a conveyor speed sensor 23 may be achieved through the combination of an accurate positioning system and sensory feedback from wireless sensors throughout the vehicle. Additionally a mobile device 27 may be utilized to automate a spreader's hydraulic system based on location, spreading history and the specific environment the vehicle was transiting. Wireless capability may enable easier integration, easier installation, and more direct connection to the mobile device computer. Moreover, in certain embodiments the wireless communication may be “plug and play,” that is, a sensor may be added to a vehicle component, such as a spreader, and when the sensor device is activated the mobile device may automatically communicate with, or “see” the device and automatically configure the device for interaction with the software running on the mobile device.

Additionally, or alternatively, each of the wireless sensors illustrated in FIGS. 1-23 may contain components similar to those included in the embodiment of FIG. 4, but it is within the scope of this disclosure that the wireless sensors may have additional (fewer) or other components as well.

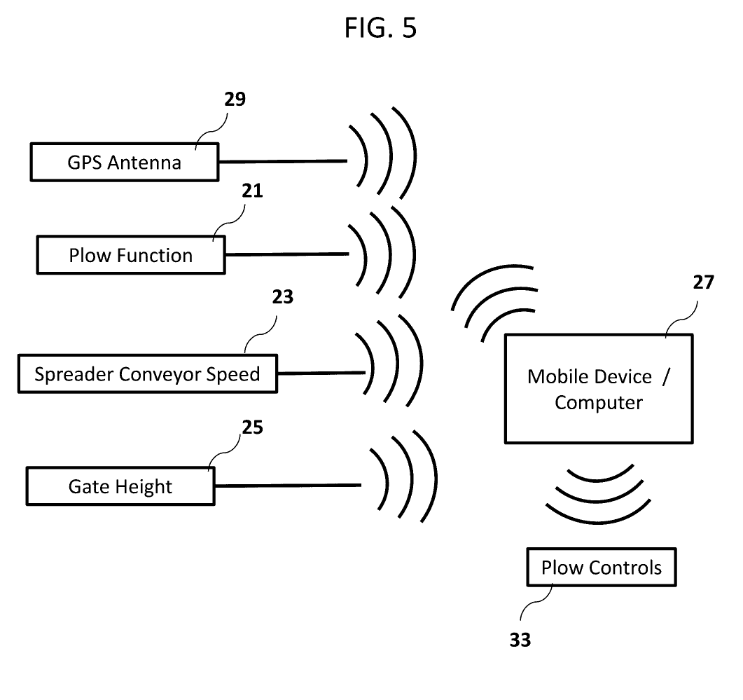

FIG. 5 illustrates an embodiment that is similar to that in FIG. 4, however it includes the concept of controlling plow controls 33 wirelessly through a mobile device 27 based on the input data from the various wireless sensors, such GPS 29, plow function 21, conveyer speed 23, and gate height 25. The plow may be controlled concurrently with any other controlled devices such as the spreader (FIG. 4) or it may be controlled individually and independently of any other devices.

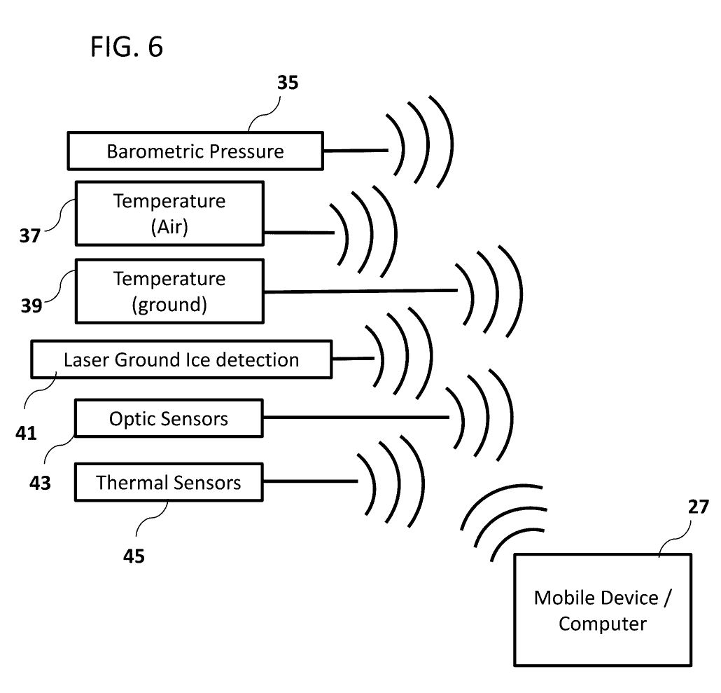

Road maintenance operations are greatly affected by weather conditions. Having the ability to remotely mount multiple weather sensors throughout a maintenance vehicle would be helpful in collecting data as well as in helping operators make better decisions in the field (and remotely) and in real-time. FIG. 6 provides an example of an embodiment comprising sensors mounted to a mobile vehicle for measuring and recording information about the weather which may include but is not limited to: barometric pressure 35, air temperature 37, ground temperature 39, ice detection 41, thermal sensors 45 as well as optical sensors 43 (utilizing cameras etc.).

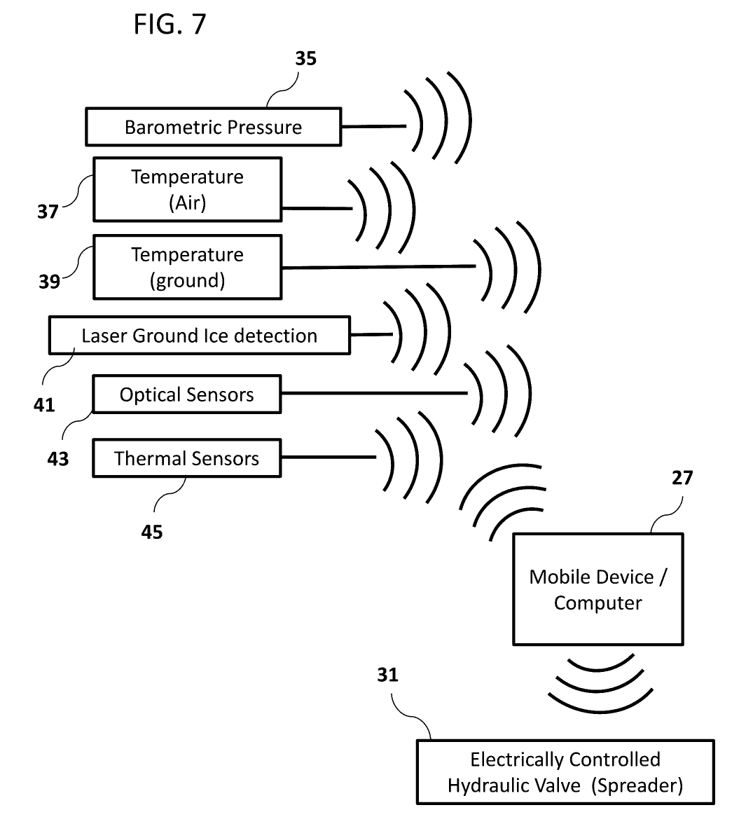

Having real-time weather information wirelessly connected to a mobile device at the vehicle may allow a winter road maintenance system to automatically control equipment thus optimizing spreading quantities appropriately. Both air temperatures and ground temperature sensors may provide useful information to operators engaged in winter road maintenance. For example, when deicing roadways, best management practices suggest that winter road maintainers should apply less material if temperatures are warming and more material if temperatures are cooling and not to apply any material bellow certain temperatures. Also, winter road maintainers may find certain areas of the roadway that may require more material than others (frozen shadow areas, low lands, wind drifts, and bridges as examples). FIG. 7 illustrates an embodiment comprising a number of sensors that may be utilized to observe present road and weather conditions at the vehicle; the sensors 35, 37, 39, 41, 43, and 45 may be connected wirelessly to a mobile device 27, which in turn may have the capability to electronically control the spreader's hydraulic valve 31 wirelessly from the mobile device. Furthermore, this embodiment may comprise sensors allowing it to regulate flow of material depending on the environment that the truck is transiting, for example whether the truck is transiting a typical road section or transiting an area of the road that may stay colder than other sections of roadway such as shadowy streets and bridges.

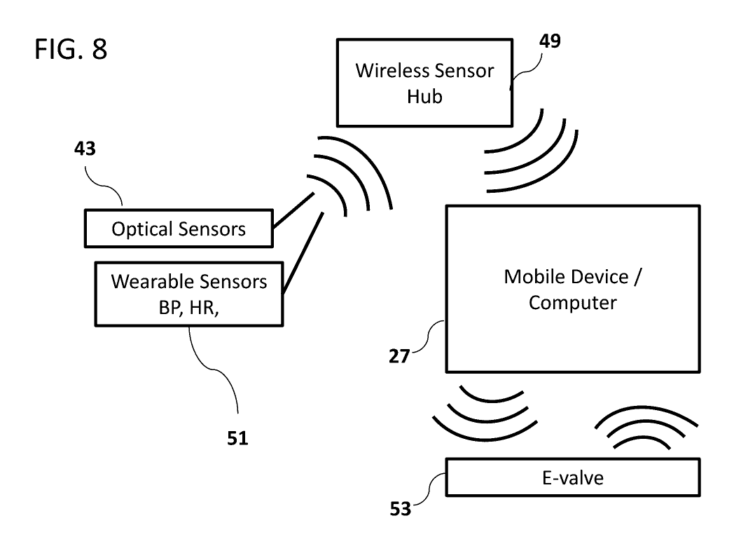

With reference now to FIG. 8; in certain scenarios the inclusion of a Wireless Sensor Hub 49 may be advantageous in the wireless system. The inclusion of a wireless sensor hub may be included in the system for numerous reasons including (but not limited to) extending the range of transmission/reception of sensor information and/or to increase the number of sensors able to communicate with a given mobile device. FIG. 8 illustrates an embodiment wherein multiple sensors, for example optical sensors 43 or wearable sensors 51, share a wireless hub which may enable wireless communication to a mobile device 27. The mobile device 27 may process the information locally or remotely and adjust the control of the system shown using the E-valve 53, in the embodiment. As an example, electronic valves (or E-Valves) 53 are typically utilized to regulate the hydraulic flow on hydraulic systems. In the case of winter road maintenance vehicles, the E-valve 53 may be used in controlling the hydraulics that controls the spreading system.

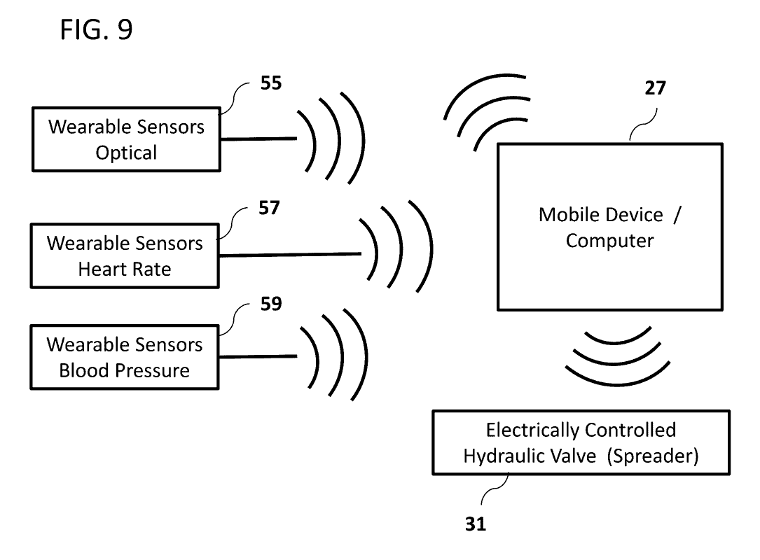

When individuals are working long hours and operating heavy machinery it is important to make sure that they are awake and healthy enough to properly perform the operation. Wearable sensors can help to monitor the state of the driver and adjust the spreader controls appropriately. FIG. 9 shows several examples of wearable sensors that may assist the operator in conducting maintenance operations. Wearable optical sensors 55 are capable of seeing both the perspective of the driver as well as monitoring the state of the drivers eyes and his blink status. This information may also be made available to the operator. Heart rate 57 and blood pressure 59 may also be monitored through wearable sensors. For example, monitoring health status of the operator while operating maintenance equipment may not only be helpful for collecting useful information, but may also be useful in monitoring alertness, assisting in the establishment and regulation of certain minimum alertness and health thresholds, or for controlling the operation of heavy equipment or accessories such as the spreader hydraulic valve 31.

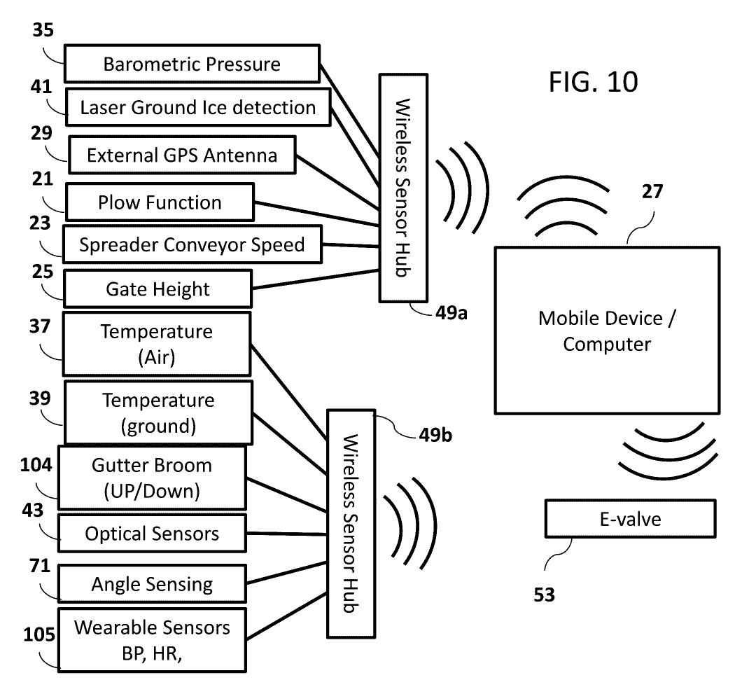

FIG. 10 provides an example of how many sensors may be employed though the utilization of multiple wireless hubs 49a and 49b with the mobile device 27 for optimization and control of a spreading system, such as for example controlling an electric valve 53 which is typically used to regulate the hydraulic flow on hydraulic systems. These sensors may comprise environmental sensors such as, for example, barometric pressure 35, ice detection 41, temperature of the air 37 or ground 39, and optical sensors 43. In addition, the sensor array may include onboard sensors that detect various status' and metrics on the vehicle such as plow function 21, conveyor speed 23, gate height 25, gutter broom state 104, and angle of any structure on the vehicle 71. Finally, the sensor array may comprise one or more sensors that detect an attribute of the driver such as wearable sensors 105.

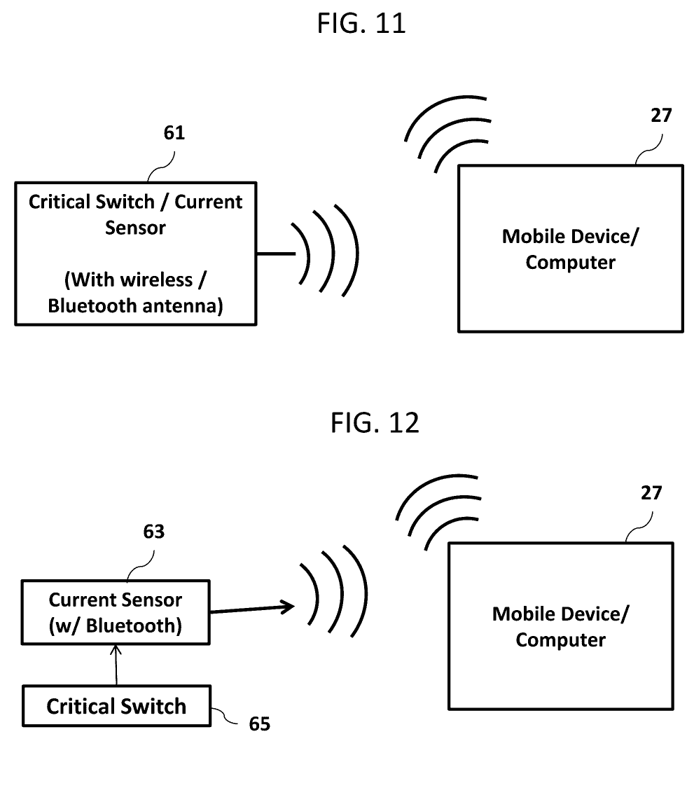

FIG. 11 provides an example of a current sensor 61 (or voltage sensor) integrated with a mobile device 27 using a wireless communication system (or control system). There are a wide array of switches and control panels on utility vehicles where the easiest way to detect the function of critical switches on a panel may be through the implementation of wireless current (or voltage) sensing retrofits capable of communicating the status of a switch wirelessly to a mobile device. A common application for monitoring the status of a critical switch would be in street sweeping operations, where there are limited areas on the exterior of the truck to mount retrofit sensors, making the voltage monitoring of critical switches a practical alternative for operational monitoring of equipment when integrated with mobile devices and wireless communication capability. The signal from the retrofitted sensor 61 may be transmitted to the mobile device 27 and processed along with the multitude of other signals depicting the status of various systems and devices in or on a vehicle.

FIG. 12 provides another schematic example of how a current sensor 63 (or voltage sensor) can be retrofit to an existing control switch 65 for continuously communicating status wirelessly to a mobile device 27.

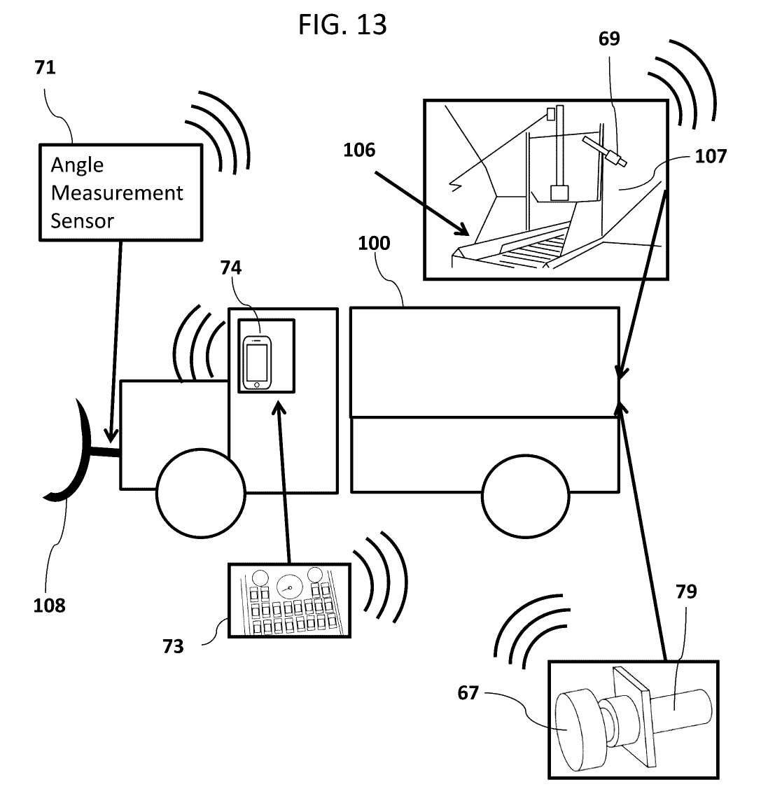

FIG. 13 depicts various sensors mounted at locations in and around a winter road maintenance vehicle. For example, a rotational rate sensor 67 may be affixed to an exposed end of the shaft 79 of a conveyor located on a material spreader; the shaft 79 typically being located either near the front or near the rear of the material spreader 106. 69 depicts a gate height sensor that can be affixed to the rear of a material spreader's hopper 107 and can be capable of measuring adjustments to the height of the gate through angle measurements. 71 depicts the location of an angle measurement sensor for measuring the status of the plow 108 using angle measurements (e.g. plow “up” or plow “down”). 73 depicts switches to be monitored within the cab of the truck using wireless current sensing methods to communicate switch status to a mobile device within the cab. In addition, a mobile device 74 may be located in the passenger compartment for receiving wireless communication from sensors mounted throughout the vehicle.

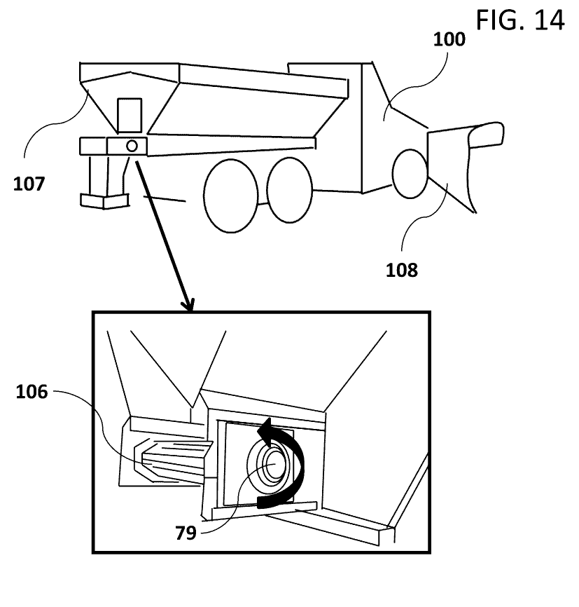

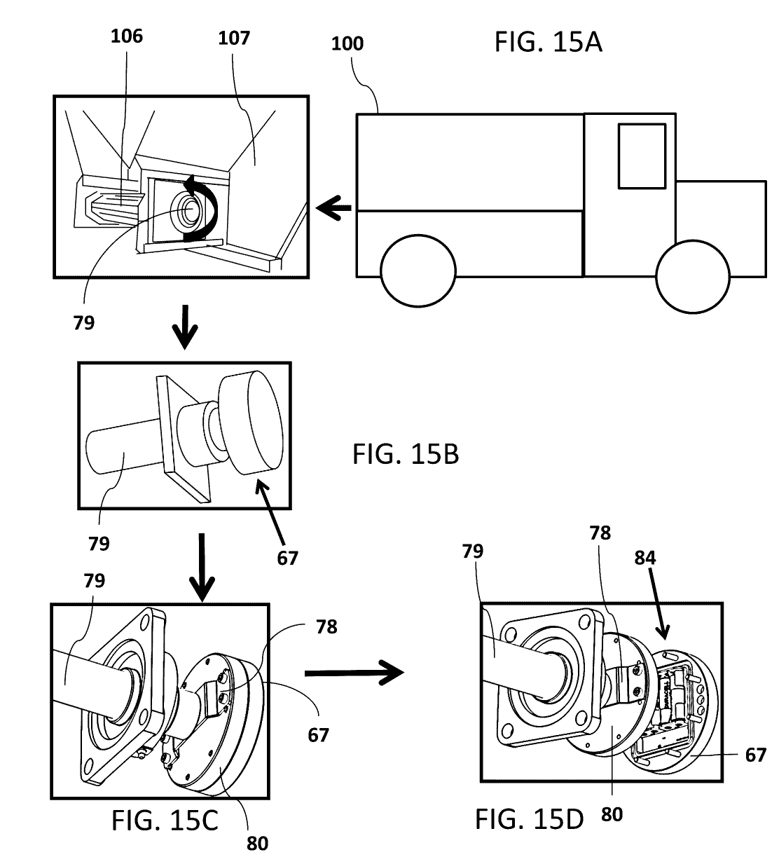

FIG. 14 depict the location where a rotational sensor 67 (see FIGS. 15A-D) may be mounted on a shaft 79 of a material spreader 106. The sensor (not shown in this figure) may measure rate of rotation and/or absolute angle. The end of the exposed shaft indicated by 79 is a representative location where a rotation rate sensor may be retrofit as this type of shaft 79 arrangement with an exposed end is common in material spreader systems. Mounting in this manner requires that the sensor be wireless, and this mounting location on the shaft 79 provides for easy retrofits on a wide array of spreader types.

An embodiment of a wireless rotational sensor is depicted in more detail in FIGS. 15 A-D, which depict various components of a rotational rate sensor in perspective views. FIG. 15A depicts a perspective view of the shaft 79 that may be located at a rear end of a conveyer 106. FIG. 15B depicts a rotational sensor 67 mounted to the end of the conveyor shaft 79. Likewise, FIG. 15C provides another, more detailed, view of a rotational sensor 67 comprising a mounting back-plate 80 and a mounting bracket 78 for attaching the rotational sensor 67 to the shaft 79. The bracket 78 may, for example, be welded, bonded, or bolted onto the end of the shaft 79 in order to mount the rotational rate sensor 67 allowing an easy retrofit for the rotational rate sensor 67 onto the exposed portion of spreader shaft 79. FIG. 15D depicts a rotational rate sensor 67 in an exploded view at the mounting location of wherein a rotational rate sensor would attach to a typical shaft 79 of a material spreader. The rate sensor 67 comprises an electronics module 84 that may be located inside of the back-plate 80, which is in turn attached to the conveyer shaft 79 via the mounting bracket 78.

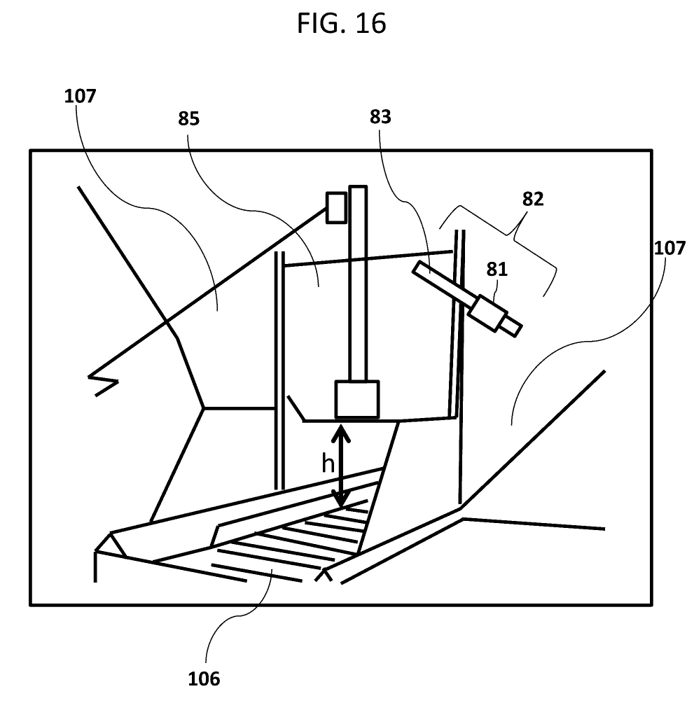

FIG. 16 is a detail perspective view of the rear end of a material spreader hopper 107 comprising a gate 85 and a conveyer 106, the gate being positioned open at a height indicated by the arrow h. An angle measurement sensor 82 is configured to measure both absolute gate height h and changes of gate height h on the rear end of the hopper 107. 81 depicts a wireless angle sensor enabling retrofitting and consisting of a reach arm 83 mounted between the spreader/hopper 107 and the gate 85; the reach arm 83 changes its angle respectively with changes in gate height h. The distance that is measured is indicated by h; this opening allows more material to pass along conveyor when gate is in the raised position (increasing h).

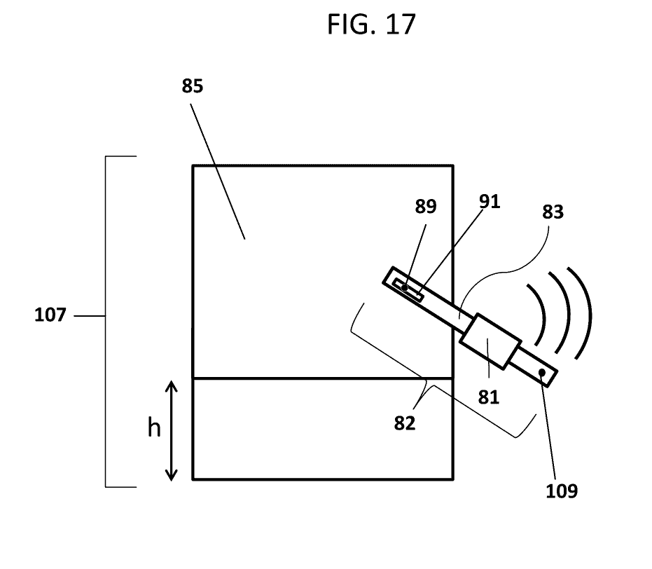

FIG. 17 illustrates one method for mounting an angle sensor 82 to the rear end of a hopper 107 wherein a mounting pin 89 is used with the wireless angle sensing measurement system 82, in this case depicted on a raised gate. 89 depicts a set pin connection for the sensor 82 as mounted to the gate 85, and 91 depicts a slot cut into the reach arm 83 or mounting hardware that the sensor is mounted to. As the gate 85 moves up and down, the set pin is able to travel up and down through the slot 91 corresponding to changes in the gate height h, freely altering the angle of the sensor 82 and resulting in different angle measurement readings from the wireless or wired sensor 81 as the sensor 82 pivots on a fixed, but rotatable point 109 on the hopper 107.

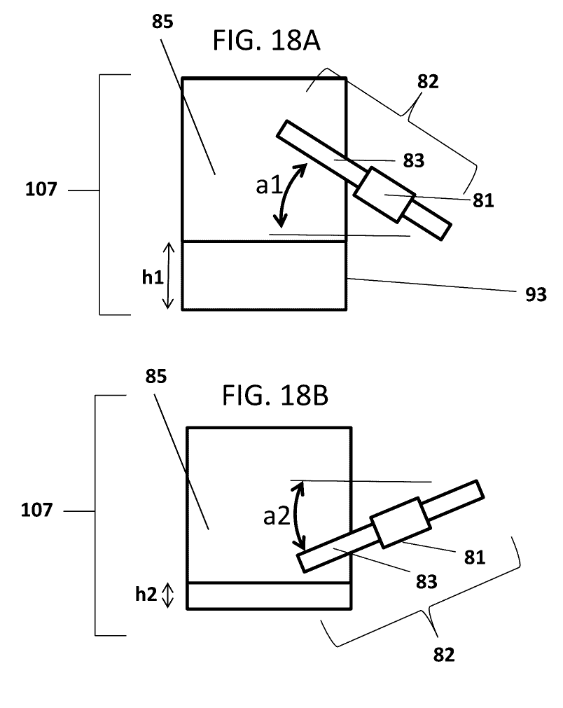

FIGS. 18A-B illustrates the wireless angle measurement sensor in operation. FIG. 18A shows the gate in the lifted position resulting in a larger gate opening h1. As such, the wireless angle measurement sensor 81 orients at a significantly different angle a1 (up position), than can be seen in FIG. 18B where the orientation of the wireless angle measurement sensor 81 is seen angled in the down position (angle a2) and the gate height h2 is observed as minimized.

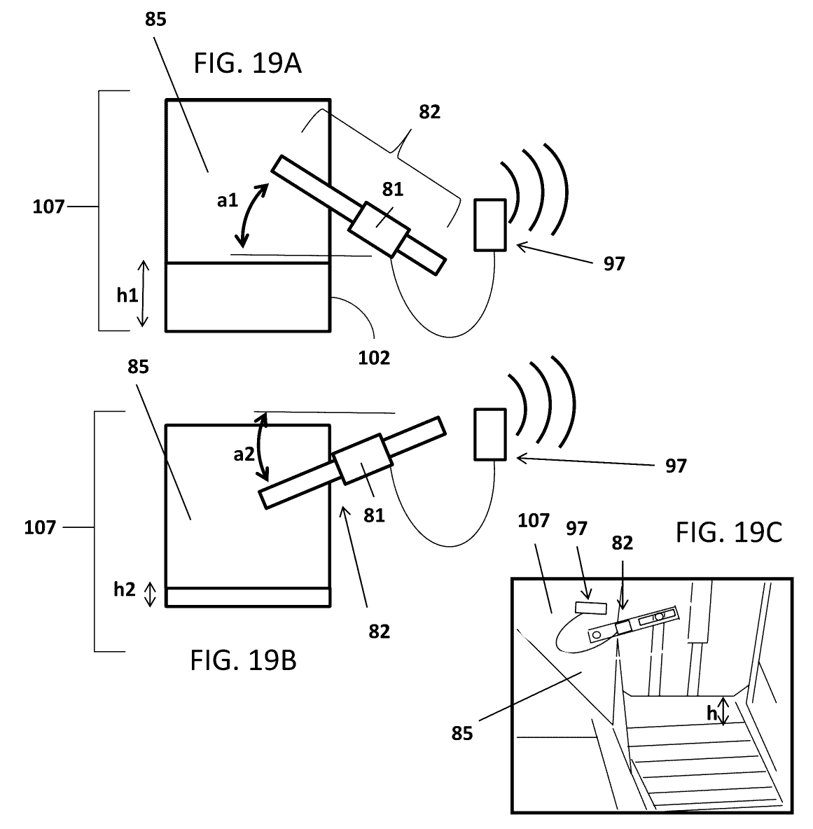

FIGS. 19A-C illustrate a more detailed view of the wireless angle sensor 81 and the difference of the two angle measurement sensors between FIGS. 19A and 19B with different gate height settings. The figure also illustrates the implementation of a reference angle measurement sensor 97 mounted to measure changes in the truck's orientation on the roadway, in addition to the angle sensor 81 mounted to measure changes in gate height. FIG. 19A demonstrates the orientation of the angle sensor 81 when the gate is elevated to a raised position with a height h1, and FIG. 19B indicates the orientation of the angle sensor 81 when the gate is in the lowered position with a height h2 the reference angle measurement sensor 97 measures the orientation of the truck on the roadway as a reference to the angle sensor system 82 mounted on the gate 85. FIG. 19C further illustrates, in perspective view, one example of a method to mount the sensor system 82 to the rear of a spreader hopper 107 as well as to an adjustable gate 85 with the gate in the raised position h.

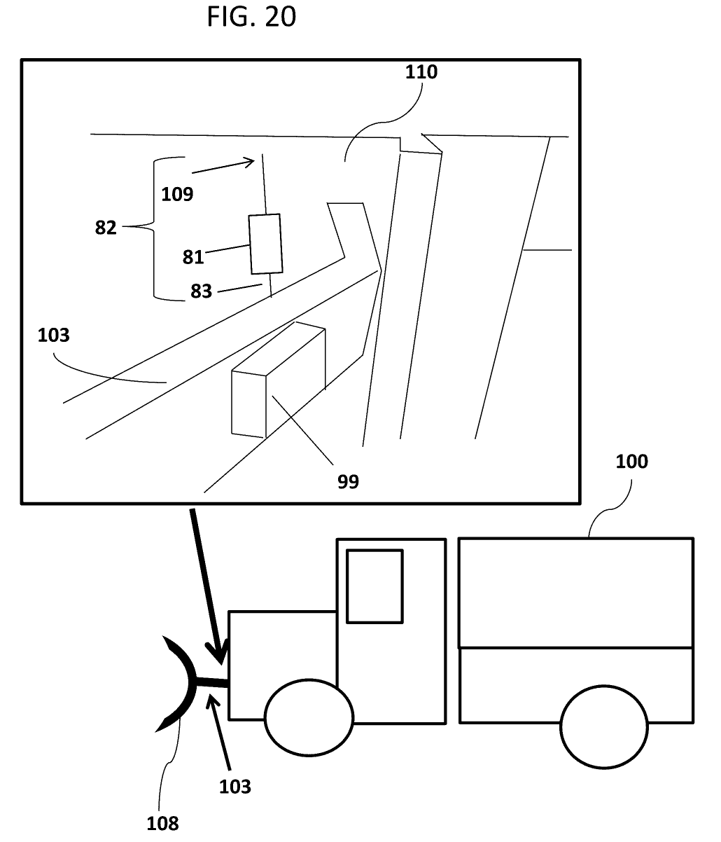

Now with reference to FIG. 20 which illustrates a potential location of a wireless angle measurement sensor in use on a plow 108 of a plow truck 100. Typically, proximity sensors 99 are used throughout the industry to indicate whether a plow is up or down, but the use of an angle sensor may be more effective and more easily retrofitted, as indicated by 82 of FIG. 20. Thus, an angle sensor system 82 may be used in a similar manner as described elsewhere in this disclosure for gate height sensing (see FIGS. 16-19). In the configuration illustrated in FIG. 20, however, the angle sensor system 82 may be pivotally attached on one end 109 to a fixed structure 110 in the front of a vehicle 100 and attached to a movable plow mechanism 103 at the opposite end of a reach arm 83.

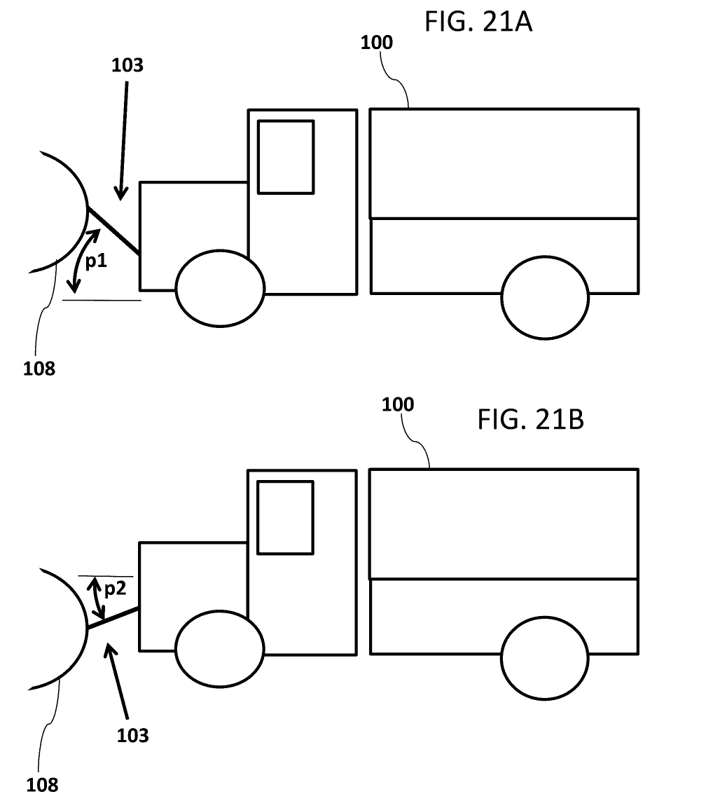

Plow mechanisms may effectively be equipped with angle sensing to indicate the status of the plow in operational monitoring as shown schematically in FIGS. 21A-B. In FIG. 21A that the plow 108 is up showing a distinct upward angle p1 of the plow mechanism 103 and FIG. 21B shows the plow 108 oriented in a downward angle p2 of the plow mechanism 103, the angle of which may be measured as described elsewhere in this disclosure; see for example the angle sensor system 82 in FIGS. 16-20.

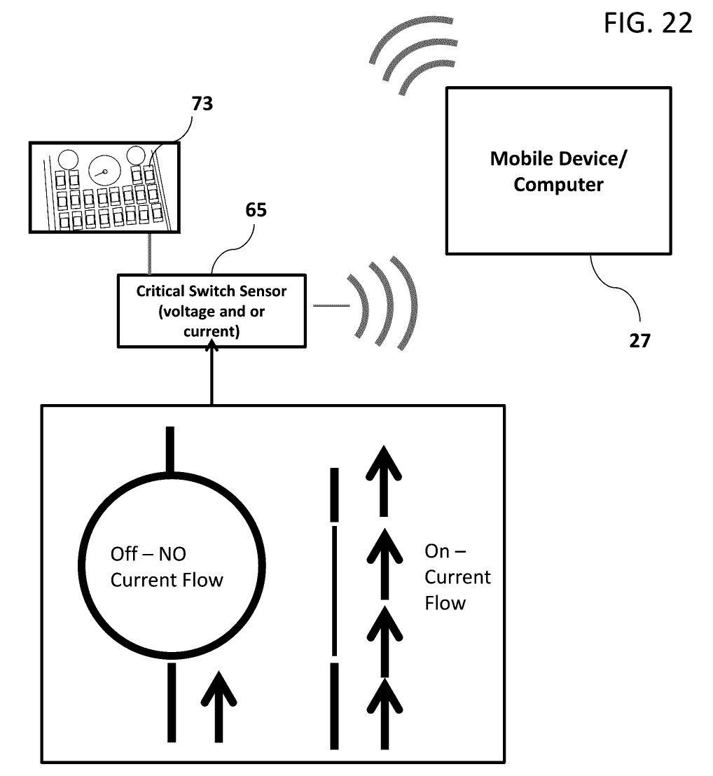

With reference to FIG. 22, which schematically indicates how a voltage or current sensor 65 may be equipped to transmit the status of the voltage flow (or no flow) wirelessly to a mobile device 27 for indicating the status of critical switches 73, which reside in the cabin of the vehicle, for operational monitoring.

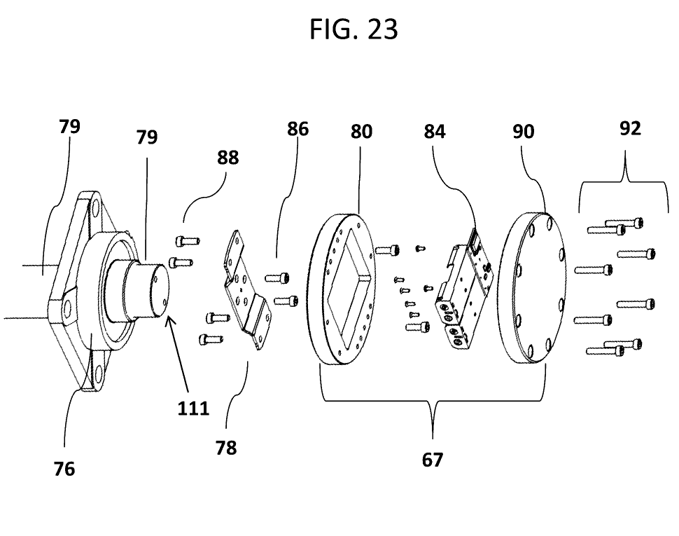

With reference to FIG. 23, an exemplar embodiment of a rotational rate sensor 67 that is capable of being retrofitted to a vehicle spreader shaft 79 is shown in an exploded view. The sensor 67 is comprised of a back-plate 80 and a front plate 90 that together house the sensor electronics module 84 and may be attached to each other through an array of bolts 92. The electronics module 84 contains all of the devices required to sense and transmit the rotational rate, including a printed circuit board, rotational sensor, and a battery or other power source which, in general, would be known to one skilled in the art.

The rotational rate sensor 67 may be retrofitted to the spreader/conveyer shaft in a variety of arrangements. FIG. 23 illustrates one such arrangement in which two bolts 86 are threaded into the end of the spreader shaft 79 in order to capture and attach a mounting bracket 78. The mounting bracket is, in turn, attached to the rotational rate sensor 67 via an array of bolts 88. Thus, the only modification to the truck is the drilling and tapping of holes 111 in the shaft 79. Furthermore, the sensor 67 may be attached to the shaft 79 via other methods such as, but not limited to, bonding, welding, or clamping.

While this invention has been particularly shown and described with references to example embodiments thereof, it will be understood by those skilled in the art that various changes in form and details may be made therein without departing from the scope of the invention encompassed by the appended claims.

What is claimed is:

1. A system for controlling vehicle mounted maintenance equipment comprising:
an electronic control system configured to operate the vehicle mounted maintenance equipment including:
an electronic controller for changing an operating condition of the maintenance equipment;
a sensor for determining the status of the maintenance equipment;
a navigational system for determining a geographical position of the vehicle; and
a display showing a real-time indicator trail of the vehicle.

2. A system for retrofitting a road maintenance vehicle for wireless control, comprising:
a rotational rate sensor comprising a self-contained battery pack and wireless communication module,
a mounting bracket to mount the unit to a rotating shaft, and
a mobile device for receiving a signal from the rotational rate sensor.
